(19) United States
(12) Patent Application Publication
(10) Pub. No.: US 2007/0148588 A1
(43) Pub. Date: Jun. 28, 2007

(54) METHODS OF RELEASING PHOTORESIST FILM FROM SUBSTRATE AND BONDING PHOTORESIST FILM WITH SECOND SUBSTRATE

(75) Inventors: Chin-sung PARK, Gyeonggi-do (KR); Kyu-youn HWANG, Gyeonggi-do (KR); Jin-tae KIM, Gyeonggi-do (KR); Young-sun LEE, Gyeonggi-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Gyeonggi-do (KR)

(21) Appl. No.: 11/613,629

(22) Filed: Dec. 20, 2006

(30) Foreign Application Priority Data
Dec. 23, 2005 (KR) 10-2005-0128745

(51) Int. Cl. G03C 1/00

(52) U.S. Cl. 430/270.1

(57) ABSTRACT

Disclosed herein is a method of releasing a photoresist film from a substrate, which includes forming a self-assembled monolayer (SAM) on a substrate; coating the SAM with a photoresist film; and rinsing the substrate with an alcohol or an acid. According to the photoresist film releasing method, a photoresist film can be easily released from a substrate without damage after patterning. A method of bonding a released photoresist film with a substrate includes arraying a second substrate and the photoresist film released from a first substrate, and baking the second substrate. According to the bonding method, the photoresist film can be perfectly bonded with a second substrate without generating a crevice even though an additional adhesive is not used.

This application claims priority to Korean Patent Application No 10-2005-0128745, filed on Dec. 23, 2005 in the Korean Intellectual Property Office, and all the benefits accruing therefrom under 35 U.S.C. §119, the contents of which are incorporated herein by reference in its entirety.

### BACKGROUND OF THE INVENTION

1. Field of the Invention

The present invention related to a method of releasing of photoresist film from a substrate, and a method of bonding the photoresist film with a second substrate.

2. Description of the Related Art

A microfluidic device is a device including an inlet, an outlet a reaction chamber, and a microchannel connecting the inlet, the outlet, and the reaction chamber. The microfluidic device can and also include a micropump for transferring fluids, a micromixer for mixing the fluids, a microfilter for filtering the fluids, and the like in addition to the microchannel.

Microfluidic devices are used in microanalysis devices such as a Lab-on-a-chip (LOC), which perform a series of biological analysis processes including cell enrichment, cell lysis, biomolecule refinement, nucleic acid amplification and separation, protein separation, hybridization reaction, and detection.

A microfluidic device can be formed using a silicon substrate and a glass substrate. To form a microfluidic device having an inlet, an outlet and a reaction chamber, a silicon substrate having a groove and a glass substrate having an inlet are contacted with one another, and the silicon substrate and the glass substrate are bonded using for example an anodic bonding method. However, such a method can be expensive because sand blasting must be performed to form the inlet and outlet. Therefore, a process in which a glass substrate is not used is desirable.

Another method of manufacturing a microfluidic device makes use of a photoresist material such as a bisphenol A novolak resin. If a photoresist is directly coated on a silicon substrate in which a groove is formed, the groove can be clogged such that a reaction chamber cannot be formed. Therefore a photoresist substrate and the lower silicion substate in which the groove is formed should be bonded after separately manufacturing the photoresist on a separate substrate. However, the photoresist film, especially, when formed of the bisphenol A novolak resin, is not well released from a substrate because of the epoxy characteristics thereof.

A method of separating a photoresist film from a substrate includes etching the substrate. In this method, the potoresist film is formed by coating a photoresist on the substrate. The photoresist is patterned by lithography and the substrate is removed by dry etching or wet etching. However, the method is not economically feasible and damage to the photoresist film often occurs during the etching process.

Another method of separating a photoresist film from a substrate includes using an adhesive tape to attach the photoresist film to the substrate. In this method, an adhesive tape, such as a polyimide film (e.g., a KAPTON film commercially available from DuPont) is applied to the top of a substrate, the adhesive tape is coated with a photoresist to form a film, the photoresist is patterned by lithography, and the patterned photoresist film is released from the adhesive tape. However, this method can damage the photoresist film during a releasing process since the photoresist is very thin (e.g., on the order of tens to hundreds of micrometers).

### BRIEF SUMMARY OF THE INVENTION

The present invention includes providing a method of releasing a photoresist film from a substrate without damaging the photoresist film.

The present invention also includes providing a method of solidly bonding the photoresist film with a second substrate.

The present invention also includes providing a photoresist film which is formed by the releasing method.

The present invention also includes providing a photoresist film bonded with a second substrate by the bonding method.

In an exemplary embodiment, a method of releasing a photoresist film from a substrate includes forming a self-assembled monalayer (SAM) on the substrate; coating a photoresist film on the SAM; and rinsing the substrate with alcohol or an acid.

The substrate can be selected from the group consisting of silicon, glass, quartz, metals, and polymers.

The SAM can be formed of a compound including a silane group.

The material forming the SAM can be octadecyltrichlorosilane (ODC), octadecyldimethyl (3-trimethoxysilylpropyl) ammonium chloride (OTC), or polyethylenimine tri-methoxy-silane (PEIM).

Forming the SAM on the substrate may include dissolving an SAM-forming material in solution and soaking the substrate into the solution.

The photoresist may be a negative photoresist.

The photoresist may be a bisphenol A novolak resin.

The thickness of the photoresist may be about 50 to about 1,000 micrometers.

Coating the photoresist film on the SAM may include spin-coating a photoresist liquid on the SAM and baking the substrate at about 50 degrees Celsius (° C.) to about 100° C.

The alcohol can be selected from the group consisting of isopropyl alcohol (IPA), ethanol, propanol, and butanol.

The acid can be selected from the group consisting of a buffered oxide etchant (BOE) and hydrofluoric acid (HF).

The method may further include patterning the photoresist film by lithography after coating the photoresist on the SAM.

The patterning of the photoresist film may include irradiating about 100 to about 600 milliJoules per square centimeter (mJ/cm²) of ultraviolet (UV) light onto the phoresist film through a mask when the thickness of the photoresist is about 50 to about 1,000 micrometers.

The patterning of the photoresist film can include a post-exposure baking (PEB) process of heating the photoresist film from 65° C. to 95° C. and cooling the photoresist film to room temperature.

In another exemplary embodiment, a method of bonding a released photoresist film and a substrate includes arraying a second substrate and a photoresist film released from a first substrate using a method comprising forming a SAM on the first substrate, coating the SAM with the photoresist film, exposing the substrate with UV, baking the first substrate and rinsing the substrate with an alcohol or an acid; and baking the second substrate.

A microstructure can be formed in the second substrate.

The post-exposure baking may include a first baking at about 60° C. to about 70° C. for about one to about ten minutes, and a second baking at about 110° C. to about 150°C. for about 0.5 to about two hours.

In another exemplary embodiment, a photoresist film is formed by the releasing method and used as a substrate of a reaction chamber of a microfluidic device.

In another exemplary embodiment, a photoresist film bonded with a second substrate is obtained by the bonding method described above and used as a reaction chamber of a microfluidic device.

### BRIEF DESCRIPTION OF THE DRAWINGS

The above and other features and advantages of the present invention will become more clearly understood from the following detailed description taken in conjunction with the accompanying drawings, in which:

FIGS. 1A through 1F are cross-sectional schematic illustrations of an exemplary embodiment of a method or releasing a photoresist film from a first substrate and bonding the released photoresist film to a second substrate according to the present invention;

FIGS. 2A is a photograph of an exemplary embodiment of a bisphenol A novolak film having a thickness of about 500 micrometers in which a uniform pattern has been formed that has been released from a substrate according to the present invention;

FIG. 2B is a photograph of an exemplary embodiment of a bisphenol A novolak film having a thickness of about 200 micrometers in which a uniform pattern has been formed that has been released from a substrate according to the present invention;

FIG. 2C is a photograph illustrating the bisphenol A novolak film of FIG. 2B bonded with a silicon wafer in which a uniform pattern is formed;

FIG. 2D is a photograph illustrating the silicon wafer of FIG. 2C after being diced;

FIG. 3A is a cross-sectional schematic illustration showing that it is difficult to perform perfect bonding without crevices between a photoresist film and a second substrate when bonding a second substrate and photoresist film without releasing the photoresist from a first substrate;

FIG. 3B is a cross-sectional schematic illustration of perfect bonding without crevices between a photoresist film and a second substrate made by a method of the present invention;

FIG. 4A is an electron microscope image of a silicon wafer and a bisphenol A novolak layer which were bonded by a method according to the present invention; and

FIG. 4B is an enlarged view of the inset of FIG. 4A.

### DETAILED DESCRIPTION OF THE INVENTION

The present invention will now be described more fully hereinafter with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, and the like may be used herein to describe various elements, components, regions, layers and/or sections, these elements, components, region, layers and/or sections should not be limited by these terms. These terms are only used to distinguish one element, component, regions, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, components, but do not prelude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise “beneath” other elements or features would then be oriented “above” the other elements or features. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

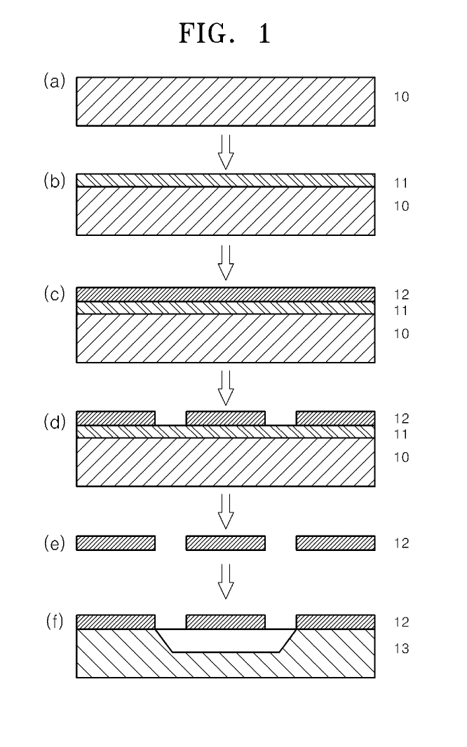

An exemplary embodiment of a method of releasing a photoresist film from a substrate according to the present invention includes forming a self-assembled monolayer (SAM) on the substrate, coating the SAM with a photoresist film, and rinsing the substrate with an alcohol group or an acid FIGS. 1A through 1F are cross-sectional schematic illustrations showing an exemplary embodiment of a method of releasing a photoresist film from a first substrate and bonding the released photoresist film to a second substrate according to the present invention. Referring to FIGS. 1A and 1B, the SAM 11 is formed on a substrate 10. The first substrate 10 is not particularly limited to any material. For example, the first substrate 10 can be formed from silicon, glass, quartz a metal, or a polymer (e.g., a plastic).

Methods used in the formation of self-assembled monolayers are known, and there is no particular limitation to the material used in forming the SAM. In an exemplary embodiment, the SAM can be formed from a compound having a silane group. For example, the material can be octadecyltrichlorosilane (ODC), octadecyldimethyl (3-trimethoxysilylproyl) ammonium chloride (OTC), or polyethyleneimine tri-methoxy-silane (PEIM).

In an exemplary embodiment after the SAM was formed, a water micro-droplet was disposed on a film formed from a bisphenol A novolak resin. An exemplary bishenol A novolak resin is SU-8, which is broadly used in processes of manufacturing semiconductors and commercially available from the MICROCHEM Corporation, (U.S.A.) The contact angle between the first substrate surface and a tangent line of a part contacted by the water droplet was measured, and the relationship between contact angle and releasing properties of the bisphenol A novolak film was measured. The contact angles of the materials are shown in Table 1.

The releasing properties of the bisphenol A novolak film were best when using ODC as the SAM-forming material, followed by OTC, and PEIM Accordingly, it can be seen that a greater contact angle of the materials results in better releasing properties of the materials. This result is contrary to the following results: direct coating bisphenol A novolak on a silcon substrate has larger contact angle but inferior releasing properties compared to the direct coating of the bisphenol A novolak on a SiO₂ substrate.

TABLE 1

| Substrate | SAM-forming material | Contact angle (°) |
|---|---|---|
| Silicon | ODC | 110-115 |
| Silicon | OTC | 80-85 |
| Silicon | PEIM | 30-35 |

In an exemplary embodiment, forming the SAM 11 on the first substrate 10 includes dissolving the SAM-forming material in a solution; and soaking the first substrate 10 in the solution after the dissolving. The solution can be an ethanol solution. When the first substrate 10 is soaked in the solution, the SAM 11 is formed on the surface of the first substrate 10.

Referring to FIG. 1C, a photoresist film 12 is coated on the SAM 11. The photoresist can be a positive or negative photoresist. In an exemplary embodiment, bisphenol A novolak (e.g., SU-8) can be used to form the photoresist film 12. An SU-8 photoresist is a negative epoxy based near-UV photoresist. Since SU-8 is transparent when in the form of a layer and has excellent mechanical hardness, it is suitable as a substrate for a reaction chamber of a microfluidic device.

The thickness of the photoresist film 12 can be about 50 micrometers (μm) to about 1,000 μm. When the thickness of the photoresist 12 is less than about 50 μm, the photoresist film 12 may not be sufficiently hard. When the thickness of the photoresist film 12 is greater than about 1,000 μm, it is difficult to manufacture the structure.

The operation of forming the photoresist film 12 on the SAM 11 can include spin-coating a photoresist solution on the SAM 11; and baking at about 50 degrees Celsius (° C.) to about 100° C.

Next the photoresist 12 can optionally be patterned, such as by lithography, as illustrated in FIG. 1D. The process of patterning the photoresist film 12 can include an exposure process, a post-exposure baking (PEB) process, a development process, or a combination comprising at least one of the foregoing processes.

The exposure process includes irradiating about 100 milliJoules per square centimeter (mJ/cm²) to about 600 mJ/cm² of ultraviolet (UV) light on the photoresist 12 film through a mask if the thickness of the photoresist is about 50 μm to about 1,000 μm.

When the intensity of the UV light is less than about 100 mJ/cm² the photoresist film 12 becomes weak. When the intensity of the UV light is greater than about 600 mJ/cm², excessive cross-linking occurs in the photoresist layer, and thus the photoresist film 12 will not properly bond with a second substrate 13 in a subsequent bonding process.

The PEB process includes heating from about 65° C. to about 95° C., and then cooling to room temperature. When the cooling process is omitted, cracks can result from differences in the thermal expansion coefficients of the first substrate 10 and the photoresist film 12.

The development process can be performed for 20 minutes by using a known method. Next, referring to FIG. 1E, the first substrate 10, on which the SAM 11 and the photoresist film 12 are laminated, is rinsed with an alcohol or an acid. Here, the photoresist film 12 easily released from the SAM 11 and the substrate 10 without damage. The rinsing time is not limited, and can be about one to about ten minutes. In an exemplary embodiment, the rinsing is carried out for about one minute.

Rinsing with an alcohol is generally used in a semiconductor process in which a photoresist, for example, SU-8, is involved. Therefore, the present invention is advantageous in that the photoresist film 12 can be released by a known rinsing process.

There is no particular limitation to the alcohol used. For example, the alcohol can be selected from the group consisting of isopropyl alcohol (IPA), ethanol, propanol, and butanol. In an exemplary embodiment the alcohol is IPA.

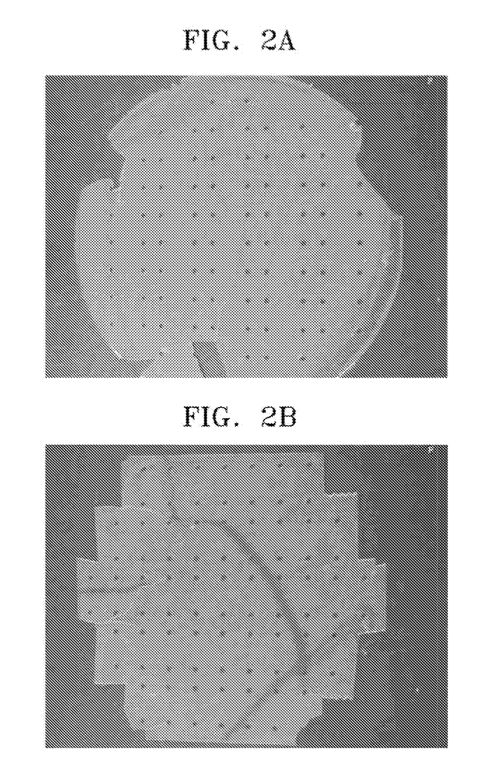

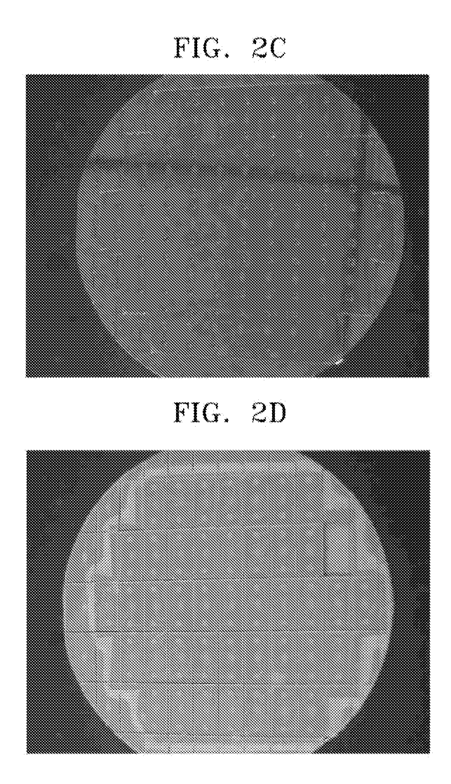

If it is difficult to release the photoresist film 12 from the first substrate 10 using the alcohol, the photoresist film 12 can be released by additionally or alternatively using an acid. There is no limitation on the particular acid used. The acid can be a buffered oxide etchant (BOE) or hydrofluoric acid (HF). In an exemplary embodiment, the acid is a BOE. FIG. 2A is a photograph of an SU-8 film having a thickness of about 500 μm in which a uniform pattern is formed that has been released from a substrate by a method according to an exmplary embodiment of the present invention, and FIG. 2B is a photograph of an SU-8 film having a thickness of about 200 μmin which a uniform pattern is formed that has been released from a substrate by a method according to an exemplary embodiment of the present invention. Referring to FIGS. 2A and 2B, since the film is formed by coating a silicon wafer with SU-8, the SU-8 film released from the silicon wafer is circular.

If a chamber of a microfluidic device is to be formed through bonding with another substrate, a plurality of holes, which can be an inlet and an outlet, are formed in the film.

The method of bonding the released photoresist film with a second substrate includes arraying a second substrate and a photoresist film released from a first substrate, and baking the second substrate, wherein the photoresist film was released from the first substrate using a method comprising forming a SAM on the first substrate, coating the SAM with the photoresist film, and rinsing the substrate with an alcohol or an acid. Referring to FIG. 1F, a micro-structure can be formed on the second substrate 13. The released photoresist film 12 can be arrayed on the second substrate 13 at room temperature. The baking operation can include a first baking at about 60° C. to about 70° C. for about one minute to about ten minutes; and a second baking at about 110° C. to about 150° C. for about 30 minutes to about two hours.

When the temperature of the first baking is below about 60° C., an error can occur in the alignment of the second substrate 13. When the temperature of the first baking is greater than about 70° C., and alignment error can cause a process failure because initial bonding is too strong to allow for adjustments. Moreover, when the first baking time is less than about one minute, partial bonding can occur because heat is not transferred evenly to all areas. When the first baking time is greater than about 10 minutes, the method is made unnecessarily long.

Moreover, when the second baking temperature is less than about 110° C., the method is made unnecessarily long. When the second baking temperature is greater than about 150° C., the photoresist layer, which is an organic layer, can be damaged. When the second baking time is less than about 30 minutes, imperfect bonding may occur because the bonding strength is weak. If the second baking time is more than about two hours, the photoresist layer, which is an organic layer, can be damaged.

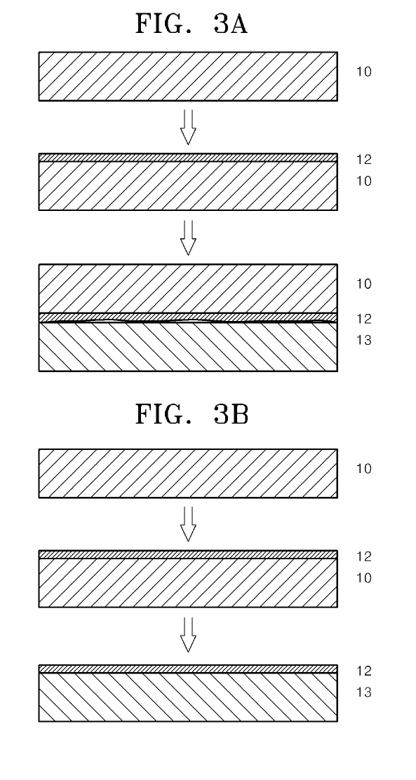

FIG. 2C is a photograph illustrating a SU-8 film of FIG. 2B bonded with a silicon wafer in which a uniform pattern is formed, and FIG. 2D is a photograph illustrating the silicon wafer of FIG. 2C after being diced. FIG. 3A is a cross-sectional schematic illustration showing that it is very difficult if not possible to achieve perfect bonding without crevices between a a photoresist film and a second substrate when bonding a second substrate and a photoresist film without releasing the photoresist from a first substrate. FIG. 3B is a cross-sectional schematic illustration of perfect bonding without crevices between a photoresist film and a second substrate made by a method of the present invention. Referring to FIG. 3A, a side which was not in contact with the substrate 10 of the photoresist 12 is put in contact with the second substrate 13. Then, since the side put in contact with the second substrate 13 can have up to 5% surface irregularity, the side cannot be bonded with the second substrate 13. Therefore, crevices between the side and the substrate are generated.

On the other hand, referring to FIG. 3B, in an exemplary embodiment of a method of the present invention, a SAM layer and a photoresist film 12 are coated on a substrate 10 and then released. Next, the side of the photoresist film 12 which was in contact with the substrate 10 is bonded with a second substrate 13. Through this process, perfect bonding can be achieved.

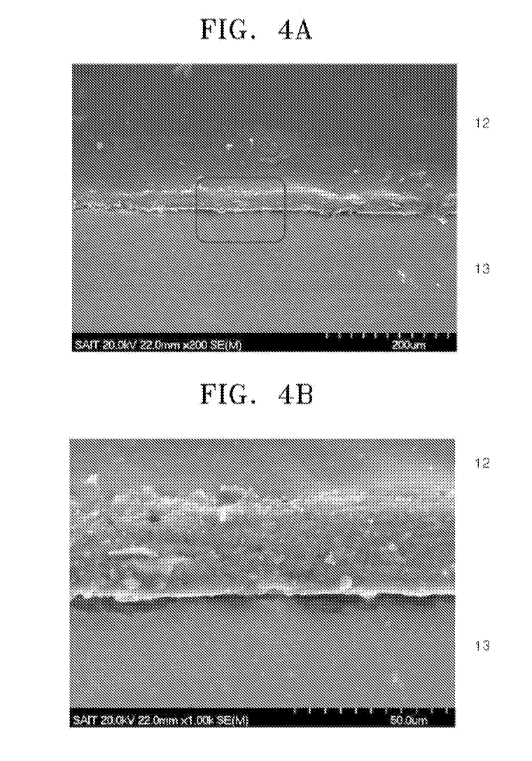

FIG. 4A is a photograph illustrating a silicon wafer 13 and SU-8 12 which were bonded by a method according to an exemplary embodiment of the present invention, and FIG. 4B is an enlarged photograph of the inset of FIG 4A. Referring to FIGS. 4A and 4B, it can be seen that the SU-8 layer 12 and the silicon wafer 13 are solidly bonded.

In an exemplary embodiment, a photoresist film is formed by the releasing method and is used as a substrate for a reaction chamber of a microfludic device. When used as a substrate of a reaction chamber of a microfludic device, the photoresist can have an inlet and an outlet be used as a substitute for a cover glass. The inlet and the outlet are produced by sandblasting. The photoresist film can be at least about 70% cheaper than a cover glass. A second substrate and a bonded photoresist film are formed by the bonding method described above and used as a reaction chamber of a microfludic device. When used as a reaction chamber of a microfluidic device, the photoresist can have an inlet and an outlet and be used as an upper substrate, and the second substrate can be used as a lower substrate and form a floor and walls.

Hereinafter, the present invention will now be described in further detail with reference to the following examples. However, these examples are given for the purpose of illustration, and are not to be construed as limiting the scope of the present invention.

### EXAMPLE 1

### Manufacture of Reaction Chamber

A SAM was formed on the surface of a first silicon wafer with a diameter of about 4 inches by washing the first silicon wafer, dissolving ODC in ethanol, and dipping the first silicon wafer in the ODC-ethanol solution for about 60 minutes. The contact angle, which was measured by dropping a water micro-droplet on the substrate on which the SAM layer composed of ODC was formed, was about 110 to about 115°.

A bisphenol A novolak resin (SU-8 2100, MICROCHEM) was double spin-coated on the first silicon wafer at about 1,000 revolutions per minute (rpm) to a thickness of about 500 μm using a spin coater. Then, the SU-8 film was formed by healing the substrate coated with SU-8 2100 at about 65° C. for about five minutes using a hot plate, increasing the temperature to about 95° C. at a rate of 1 degree Celsius per minute (° C./minute), and performing a soft baking at about 95° C. for about 15 minutes.

Next, UV light with an intensity of about 480 mJ/cm² was radiated onto the SU-8 film by using a mask aligner through a mask in which a plurality of holes were formed.

In order to prevent bending of a silicon wafer by thermal stress, PEB after exposure was performed after heating the first silicon wafer to about 65 ° C. for about one minute by using a hot plate, and increasing the temperature to about 95° C. at a rate of 1.67° C./minute, and cooling again to room temperature.

Next, the resulting sample was developed for 20 minutes and a structure having a regular pattern was formed on the SU-8 film.

The patterned SU-8 film was released from the substrate by rinsing the substrate with IPA for about one minute.

A reaction chamber having an inlet and an outlet on top was manfactured by aligning the patterned SU-8 and the second substrate having regularly patterned grooves at room temperature, heating the combination to about 65° C. for about five minutes using a hot plate, and bonding by heating to about 120° C. for about one hour.

### EXAMPLE 2

### Manufacture of Reaction Chamber

A reaction chamber having an inlet and outlet on top was manufactured using the same method as in Example 1, except that the SU-8 2100 was coated to a thickness of about 200 μm. FIG. 2B is a photograph illustrating the SU-8 film released from a substrate in the present Example. FIG. 2C is a photograph illustrating the SU-8 film of FIG. 2B bonded with a silicon wafer which has a structure of a fixed pattern. FIG. 2D is a photograph illustrating the silicon wafer of FIG. 2C after being diced.

### EXAMPLE 3

### Manufacture of Reaction Chamber

A reaction chamber having an inlet and outlet on top was manufactured as in Example 1, except that a SAM was formed using 3-trimethoxysilylpropyl and OTC and that BOE rinsing was performed in addition to IPA rinsing.

A contact angle which was measured by dropping a water microdroplet onto the substrate on which the SAM layer composed of OTC was formed was 80° C. to 85° C.

### EXAMPLE 4

### Manufacture of Reaction Chamber

A reaction chamber having an inlet and outlet on top was manufactured as in Example 1, except that a SAM was formed using PEIM, and BOE rinsing was performed in addition to IPA rinsing.

A contact angle which was measured by dropping a water micro-droplet onto the substrate on which the SAM layer composed of PEIM was formed was about 30° to about 35°.

Although the present invention has been described herein with reference to the foregoing exemplary embodiments, these exemplary embodiments do not serve to limit the scope of the present invention. Accordingly, those skilled in the art to which the present invention pertains will appreciate that various modifications are possible, without departing from the spirit and scope of the present invention as defined by the following claims.

What is claimed is:

1. A method of releasing a photoresist from a substrate, the method comprising:
forming a self-assembled monolayer on a substrate;
coating the self-assembled monolayer with photoresist film; and
rinsing the substrate with an alcohol or an acid.

2. The mehtod of claim 1, wherein the substrate is formed from a material selected from the group consisting of silicon, glass, quartz, a metal, and a polymer.

3. The method of claim 1, wherein the self-assembled monolayer is formed from a compound containing a silane group.

4. The method of claim 1, wherein the self-assembled monolayer is formed from octadecyltrichlorosilane, octadecyldimethyl (3-trimethoxysilylpropyl) ammonium chloride, or polyethyleneimine tri-methoxy-silane.

5. The method of claim 1, wherein forming the self-assembled monolayer on the substrate comprises;
dissolving a self-assembled monolayer˜forming material in a solution; and
soaking the substrate in the solution.

6. The method of claim 1, wherein the photoresist is a negative photoresist.

7. The method of claim 1, wherein the photoresist comprises bisphenol A novolak.

8. The method of claim 1, wherein the photoresist has a thickness of about 50 micrometers to about 1,000 micrometers.

9. The method of claim 1, wherein coating the self-assembled monolayer with the photoresist film comprises:
spin-coating a photoresist solution on the self-assembled monolayer; and
baking the substrate at about 50 degrees Celsius to about 100 degrees Celsius.

10. The method of claim 1, wherein the alcohol is selected from the group consisting of isopropyl alcohol, ethanol, propanol, and butanol.

11. The method of claim 1, wherein the acid is selected from the group consisting of a buffered oxide etchant and hydrofluoric acid.

12. The method of claim 1, further comprising patterning the photoresist film by lithography after coating the photoresist on the self-assembled monolayer.

13. The method of claim 12, wherein the photoresist is formed to a thickness of about 50 micrometers to about 1,000 micrometers and patterning the photoresist film comprises radiating ultraviolet light with an intensity of about 100milliJoules per square centimeter to about 600 milliJoules per square centimeter on the photoresist film through a mask.

14. The method of claim 12, wherein patterning the photoresist film comprises a post-exposure baking process comprising:
heating at about 65 degrees Celsius;
heating at about 95 degrees Celsius; and
cooling to room temperature.

15. A method of bonding a released photoresist film with a substrate, comprising:
arraying a second substrate and a photoresist film released from a first substrate using a method comprising forming a self-assembled monolayer on the first substrate, coating the self-assembled monolayer with the photoresist film, and rinsing the substrate with an alcohol or an acid; and
baking the second substrate.

16. The medthod of claim 15, wherein a microstructure is formed in the second substrate.

17. The method of claim 15, wherein the baking comprises:
first baking at about 60 degrees Celsius to about 70 degrees Celsius for about one to about ten minutes; and
second baking at about 110 degrees Celsius to about 150 degrees Celsius for about 30 minutes to about two hours.

18. A photoresist film formed by the method of claim 1, and used as a substrate of a reaction chamber of a microfluidic device.

19. A photoresist film bonded with a second substrate that is obtained by the method of claim 15, and used as a reaction chamber of a microfluidic device.
